(19) United States
(12) Patent Application Publication
(10) Pub. No.: US 2015/0168321 A1
(43) Pub. Date: Jun. 18, 2015

(54) Surface Analysis Instrument

(71) Applicant: JEOL Ltd., Tokyo (JP)

(72) Inventor: Akihiro Tanaka, Tokyo (JP)

(21) Appl. No.: 14/551,402

(22) Filed: Nov. 24, 2014

(30) Foreign Application Priority Data
Nov. 26, 2013 (JP) 2013-243913

(51) Int. Cl. G01N 23/227; G01N 23/223

(52) U.S. Cl. CPC G01N 23/2276; G01N 23/223

(57) ABSTRACT

A surface analysis instrument is offered which can intelligibly display the results of a measurement. The surface analysis instrument (100) obtains a spectrum indicating a relationship between electron kinetic energy and detection intensity by irradiating a sample with an electron beam or X-rays and detecting electrons emanating from the sample. The instrument includes a detection depth calculating portion (76) for calculating the electron detection depth from the detected electron kinetic energy and a display controller (78) for providing control such that the spectrum and information about the electron detection depth calculated by the detection depth calculating portion (76) are displayed on a display device (82).

### BACKGROUND OF THE INVENTION

1. Field of the Invention

The present invention relates to a surface analysis instrument.

2. Description of Related Art

It is known that surface analysis instruments such as Auger electron spectroscopy (AES) analyzers and X-ray photoelectron spectroscopy (XPS) analyzers are tools effective in analyzing the chemical compositions of elements present on the surfaces of samples.

In an AES analyzer, an electron beam is directed at the surface of a sample and Auger electrons emitted from the surface are detected. Then, an Auger spectrum in which the kinetic energies of the Auger electrons are plotted as a parameter. Based on this Auger spectrum, elements present on the surface of the sample can be analyzed qualitatively or quantitatively.

In such an AES analyzer, generally, the kinetic energies of electrons are plotted on the horizontal axis of an Auger spectrum displayed on a display screen, while the intensity of detection is plotted on the vertical axis (see, for example, JP-A-2009-53076).

### SUMMARY OF THE INVENTION

It is possible to obtain information about the depth of detected electrons from a spectrum derived by an AES analyzer. In particular, it is possible to estimate the depth (hereinafter may be referred to as the detection depth) at which detected electrons are produced by finding the mean free path of the detected electrons from the kinetic energies of the detected electrons using a table indicating the relationship between the kinetic energies of electrons and the mean free path. The composition of a membrane of the sample can be estimated from information about the detection depth.

For example, as set forth in JP-A-2009-53076, in a case where the kinetic energies of electrons are plotted on the horizontal axis of a spectrum displayed on the display screen and the intensity of detection is plotted on the vertical axis, it has been difficult for a user to grasp the detection depth if the user watches the display screen.

One object associated with some aspects of the present invention is to provide a surface analysis instrument capable of presenting the results of a measurement in an easily understandable manner.

(1) A surface analysis instrument associated with the present invention is adapted to obtain a spectrum by irradiating a sample with an electron beam or X-rays and detecting electrons emanating from the sample and has: a detection depth calculating portion for calculating a detection depth of electrons from detected kinetic energies of electrons; and a display controller for providing control such that the spectrum and information about the detection depth of the electrons calculated by the detection depth calculating portion are displayed on a display device.

In this surface analysis instrument, the display controller displays a spectrum and information about the detection depth on the display device and, therefore, the results of a measurement can be presented in an easily understandable manner.

(2) In one feature of this surface analysis instrument, the display controller may provide control such that electron kinetic energy and the information about the detection depth are interrelated and displayed on the display device.

In this surface analysis instrument, the display controller displays the kinetic energies of electrons and information about the detection depth in an interrelated manner on the display device and so the results of a measurement can be presented intelligibly.

(3) In another feature of this surface analysis instrument, there may be further provided a membrane structure analysis portion for finding a membrane structure of the sample from the spectrum. The display controller may provide control such that the information about the membrane structure of the sample found by the membrane structure analysis portion is displayed on the display portion.

In this surface analysis instrument, the display controller displays information about the membrane structure on the display device and so the results of a measurement can be presented in an intelligible manner.

(4) In a further feature of this surface analysis instrument, the display controller may provide control such that electron kinetic energy is plotted on a first axis of the spectrum displayed on the display device and that detection intensity is plotted on a second axis of the spectrum.

(5) In an additional feature of this surface analysis instrument, the display controller may provide control such that information about the detection depth is plotted on a third axis extending along the first axis and displayed on the display device.

In this surface analysis instrument, the display controller displays information about the detection depth on the axis extending along the axis on which the kinetic energies of electrons are plotted on the display device and, therefore, the results of a measurement can be presented in an easily understandable manner.

(6) In a yet further feature of this surface analysis instrument, there may be provided a manual control portion capable of responding to a manual control operation for selecting an electron kinetic energy. If the manual control portion responds to the manual control operation, the display controller may provide control such that the information about the detection depth corresponding to the selected electron kinetic energy is displayed on the display device.

In this surface analysis instrument, information about the detection depth corresponding to the selected electron kinetic energy is displayed on the display device by the display controller and, therefore, the results of a measurement can be presented intelligibly.

### BRIEF DESCRIPTION OF THE DRAWINGS

FIG. 1 is a side elevation, partly in block form, of a surface analysis instrument associated with a first embodiment of the present invention.

FIG. 2 is a graph showing one example of spectrum generated by a spectrum generating portion of the surface analysis instrument shown in FIG. 1.

FIG. 3 is a graph showing a relationship between electron kinetic energy and mean free path.

FIG. 4 is a graph showing a relationship between escape depth of Auger electrons and the total number of electrons.

FIG. 5 shows one example of spectrum displayed on a display device of the surface analysis instrument shown in FIG. 1.

FIG. 6 is a side elevation, partly in block form, of a surface analysis instrument associated with a second embodiment of the invention.

FIG. 7 shows one example of Auger spectrum obtained by measuring a silicon substrate surface by the surface analysis instrument shown in FIG. 6.

FIG. 8 is an enlarged view of Si LVV peak appearing near 90 eV of the spectrum shown in FIG. 7.

FIG. 9 is an enlarged view of Si KLL peak appearing near 1,600 eV of the spectrum shown in FIG. 7.

FIG. 10 is a table showing intensity ratios of Si LVV peaks and Si KLL peaks.

FIG. 11 is a table showing relationships among electron kinetic energy, mean free path, and detection depth.

FIG. 12 shows an Auger spectrum obtained after a silicon substrate surface was sputtered by Ar ions to a depth of 1 nm and an Auger spectrum obtained after a silicon substrate surface was sputtered to a depth of 2 nm.

FIG. 13 shows one example of display screen of the display device of the surface analysis instrument shown in FIG. 6, the display screen indicating information about a membrane structure.

FIG. 14 shows one example of display screen of the display device of a surface analysis instrument associated with a modified embodiment of the invention, the display screen indicating information about detection depth.

### DESCRIPTION OF THE INVENTION

The preferred embodiments of the present invention are hereinafter described in detail with reference to the accompanying drawings. It is to be noted that embodiments described below do not unduly restrict the scope of the invention delineated by the appended claims and that not all the configurations set forth below are essential components of the invention.

### 1. First Embodiment

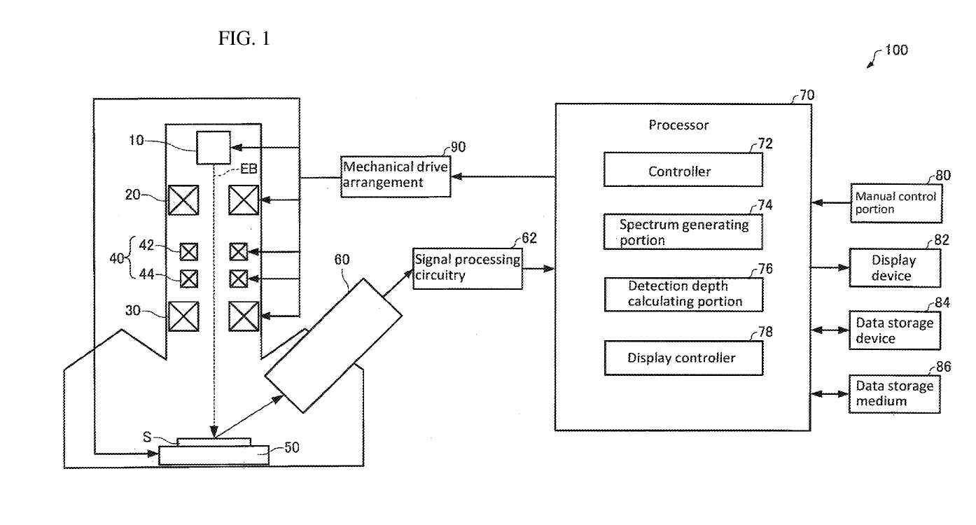

A surface analysis instrument associated with a first embodiment of the present invention is first described by referring to FIG. 1, where the surface analysis instrument is generally indicated by reference numeral 100. It is assumed herein that the instrument 100 is an AES (Auger electron spectroscopy) analyzer.

As shown in FIG. 1, the surface analysis instrument 100 is configured including an electron beam source 10, a condenser lens 20, an objective lens 30, a deflector assembly 40, a sample stage 50, an analyzer section 60, a processor 70, a manual control portion 80, a display device 82, a data storage device 84, and a data storage medium 86.

An AES analyzer is an instrument for analyzing samples by Auger electron spectroscopy (AES). Auger electron spectroscopy is a technique for analyzing elements locally present on the surface of a sample by measuring the energies of Auger electrons which are ejected from the sample after being excited by an electron beam. Since Auger electrons have small energies, they are sensitive to the surface. Hence, the outermost layer to a depth on the order of nanometers can be analyzed. Auger electrons are ejected when atoms excited to higher energy levels by incident electrons make a transition to lower levels of energy, and have energies corresponding to the differences between energy levels of orbits.

The electron beam source 10 produces an electron beam EB. For example, the electron beam source 10 is a well-known electron gun having a cathode from which electrons are released. These electrons are accelerated by anodes to release the electron beam EB. No restriction is imposed on the electron gun used as the electron beam source 10. An electron gun such as a thermionic electron gun, a thermal field emission electron gun, a cold field emission gun, or the like can be used.

The condenser lens 20 is disposed behind the electron beam source 10 (i.e., on the downstream side of the source 10 as viewed along the electron beam EB). The objective lens 30 is disposed behind the condenser lens 20. The condenser lens 20 and objective lens 30 operate to focus the electron beam EB.

The deflector assembly 40 is located between the condenser lens 20 and the objective lens 30. The deflector assembly 40 scans the electron beam EB, which has been focused by the condenser lens 20 and objective lens 30, over a sample S. In the illustrated example, the deflector assembly 40 is configured including an upper deflector 42 and a lower deflector 44 which together constitute a two-stage deflection system. Consequently, the electron beam EB can be deflected while the optical axis (center of the orbit) of the electron beam EB is aligned with the center of the condenser lens 20 and objective lens 30.

The sample stage 50 can hold and carry the sample S thereon. For example, the sample stage 50 can move the sample S horizontally and up and down and rotate and tilt the sample.

The analyzer section 60 is configured including an Auger electron analyzer for dispersing and detecting Auger electrons released from the sample S. A concentric hemispherical analyzer (CHA), a cylindrical mirror analyzer (CMA), or the like can be used as the Auger electron analyzer. For example, when a given voltage is applied to the concentric hemispherical analyzer (CHA), only electrons having an energy corresponding to the voltage pass through the analyzer and become detected. Therefore, Auger electrons can be detected by obtaining information about the amount of detected electrons while scanning the voltage applied to the CHA. The output signal from the analyzer section 60 is fed to signal processing circuitry 62.

The signal processing circuitry 62 is configured, for example, including an amplifier and an A/D converter. The signal processing circuitry 62 amplifies the output signal from the analyzer section 60, then converts the amplified analog signal into digital form, and sends the digital signal as a spectral signal to the processor 70. The spectral signal includes information about counted values obtained using electron kinetic energy as a parameter.

The manual control portion 80 operates to obtain a control signal responsive to a user's operation or manipulation and to send the signal to the processor 70. For example, the manual control portion 80 is a button or buttons, a key, a touch panel display, a microphone, or the like.

The display device 82 displays an image generated by the processor 70. The function of the display device can be implemented by an LCD, a CRT, or the like. The display device 82 displays a spectrum generated by the processor 70 or information about the detection depth at which detected electrons were generated.

The data storage device 84 acts as a working area for the processor 70. The function of the storage device 84 can be implemented by a RAM or the like. Programs, data, and related information permitting the processor 70 to perform various kinds of computational processing and control operations are stored in the storage device 84. Furthermore, the results of calculations performed by the processor 70 in accordance with various programs are temporarily stored in the storage device 84.

The data storage medium 86 that is a computer-readable medium stores data, programs, and related information. The function of the storage medium 86 can be implemented by an optical disk (such as a CD or DVD), a magnetooptical disk (MO), a magnetic disk, a hard disk, magnetic tape, a computer memory (such as a ROM), or the like. The processor 70 performs various kinds of processing of the present embodiment on the basis of a program and data stored in the data storage medium 86. Programs for causing a computer to function as various parts of the processor 70 can be stored in the storage medium 86. The programs may be delivered to the data storage medium 86 or storage device 84 from a data storage medium possessed by a host device (server) via a network.

The processor 70 performs various kinds of computational processing in accordance with programs stored in the storage device 84. The processor 70 operates as a controller 72, a spectrum generating portion 74, a detection depth calculating portion 76, and a display controller 78 described below by executing computer programs stored in the storage device 84. The functions of the processor 70 can be implemented by hardware such as various processors (e.g., a CPU, a DSP, or the like) or an ASIC (e.g., a gate array) or by software. At least a part of the processor 70 may be implemented by dedicated hardware (dedicated circuitry).

The processor 70 is configured including the controller 72, spectrum generating portion 74, detection depth calculating portion 76, and display controller 78.

The controller 72 controls the electron beam source 10, condenser lens 20, objective lens 30, deflector assembly 40, and sample stage 50. In particular, the controller 72 generates and outputs control signals for controlling the electron beam source 10, condenser lens 20, objective lens 30, deflector assembly 40, and sample stage 50. The control signals are applied to a mechanical drive arrangement 90, which in turn receives the control signals and operates the electron beam source 10, condenser lens 20, objective lens 30, deflector assembly 40, and sample stage 50.

The spectrum generating portion 74 generates an Auger spectrum on the basis of a spectral signal delivered from the analyzer section 60 via the signal processing circuitry 62.

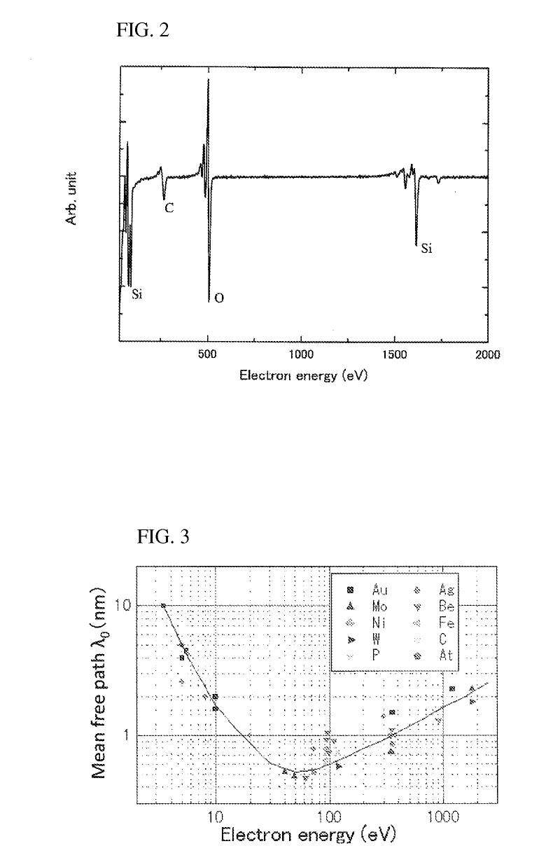

FIG. 2 shows one example of spectrum generated by the spectrum generating portion 74. In the spectrum generated by the spectrum generating portion 74, electron kinetic energy is plotted on the horizontal axis (first axis) and the detection intensity expressed in an arbitrary unit is plotted on the vertical axis (second axis). In the example of FIG. 2, the spectrum is shown in differential form. Shown peaks can be emphasized by differentiating a spectrum of detected electrons in this way.

Furthermore, the spectrum generating portion 74 may perform qualitative or quantitative analysis of the composition of elements by detecting Auger peaks appearing in the spectrum to identify the composition.

The detection depth calculating portion 76 calculates the electron detection depth from the detected electron kinetic energy.

A method of calculating the detection depth is now described. FIG. 3 is a graph showing a relationship between electron kinetic energy and mean free path. As shown in FIG. 3, as an electron travels through a solid, the distance over which the electron can move without losing its energy (i.e., mean free path) depends on the kinetic energy possessed by the electron.

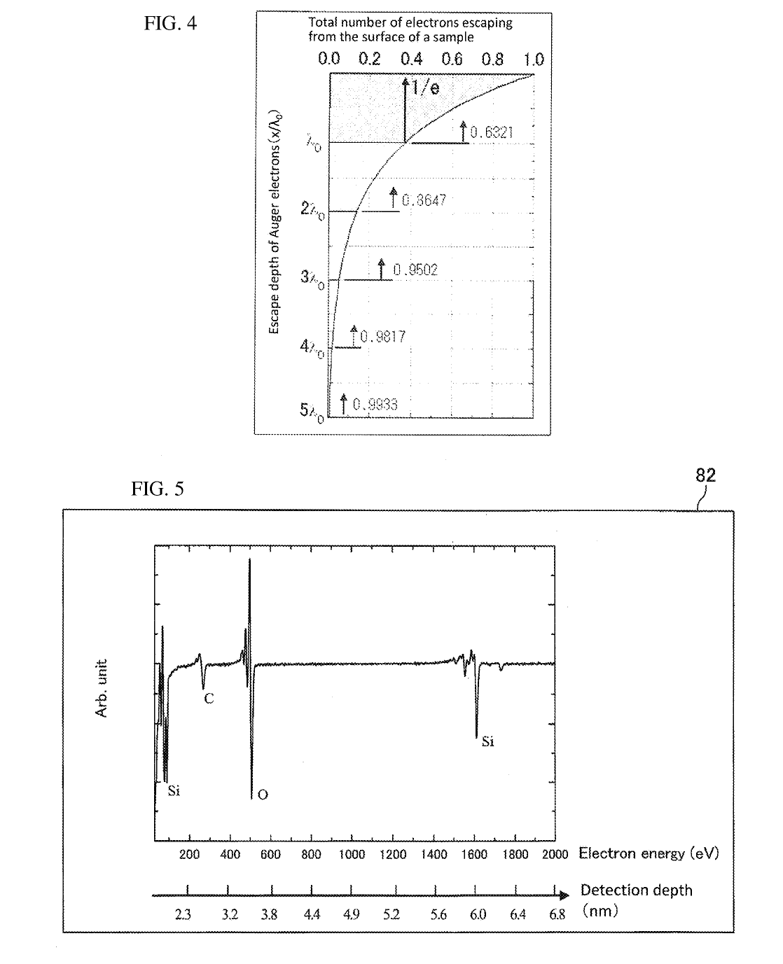

FIG. 4 is a graph showing a relationship between escape depth of Auger electrons and the total number of electrons. As shown in this graph, each electron having a mean free path λ, escapes from the surface of a sample. Assume that the total number of such electrons is equal to 1. It is assumed that the escape depth of electrons escaping from the surface of the sample decreases in a natural logarithmic manner. The ratio of electrons escaping from the surface of the sample to the escape depth has been found. An escape depth permits electrons excited within a sample by incident electrons to reach the surface of the sample without being absorbed and to become released into a vacuum.

As a result, it is seen from FIG. 4 that about 95% of the total number of escaping electrons is produced at a depth that is three times as great as the mean free path λ. From this consequence, in the present embodiment, the detection depth is set to three times the mean free path λ.

Using this result, the detection depth calculating portion 76 finds the mean free path from the electron kinetic energy, and calculates the detection depth by tripling the found mean free path. The method of calculating the detection depth from the mean free path is not restricted to this method.

The display controller 78 provides control such that a spectrum (FIG. 2) generated by the spectrum generating portion 74 and information about the electron detection depth calculated by the detection depth calculating portion 76 are displayed on the display device 82.

In particular, the display controller 78 provides control such that the electron kinetic energy is plotted on the horizontal axis (first axis) of the spectrum generated by the spectrum generating portion 74 and displayed on the display device 82 and that the electron detection intensity is plotted on the vertical axis (second axis) as shown in FIG. 2. Furthermore, the display controller 78 provides control such that the electron kinetic energy plotted on the horizontal axis of the spectrum and the information about the detection depth are interrelated and displayed on the display device 82.

FIG. 5 shows one example of display screen showing a spectrum presented on the display device 82.

As shown in FIG. 5, the display controller 78 displays a spectrum and information about the detection depth on one display screen. The display controller 78 displays information about the detection depth on a third axis extending parallel to the horizontal axis of the spectrum on which electron kinetic energy is plotted.

At this time, the display controller 78 displays them such that the value of the electron kinetic energy and the value of the detection depth correspond to each other in a 1:1 relationship. In the illustrated example, the display controller 78 displays the value of the electron kinetic energy and the corresponding value of the detection depth such that the values are arrayed along the horizontal axis.

The operation of the surface analysis instrument 100 is next described by referring to FIG. 1. If a user specifies illumination conditions (accelerating voltage of the electron beam EB, excitation currents of the lenses 20, 30, and the region illuminated with the beam EB, and so on) under which the electron beam EB is directed at the sample S to analyze it through the manual control portion 80, the controller 72 creates control signals based on the specified illumination conditions and sends the signals to the mechanical drive arrangement 90.

In response to one control signal generated by the controller 72, the mechanical drive arrangement 90 sends a drive signal for producing the electron beam EB to the electron beam source 10 such that the electron beam EB is emitted from the source 10. In response to other control signals generated by the controller 72, the mechanical drive arrangement 90 sends drive signals to the condenser lens 20 and objective lens 30 for focusing the electron beam EB onto the sample S. In addition, in response to a further control signal generated by the controller 72, the mechanical drive arrangement 90 sends a drive signal to the deflector assembly 40 for directing the electron beam EB at the specified illuminated region on the sample S.

Consequently, the electron beam EB released from the electron beam source 10 and accelerated by a given accelerating voltage is sharply focused by the condenser lens 20 and objective lens 30 onto the sample S. The beam is directed at the given region on the sample S by the deflector assembly 40.

The irradiation by the electron beam EB produces Auger electrons from the surface of the sample S. The Auger electrons are spectrally dispersed and detected by the analyzer section 60. The output signal from the analyzer section 60 is sent as a spectral signal to the processor 70 via the signal processing circuitry 62. The spectral signal is stored, for example, in the data storage device 84.

The spectrum generating portion 74 generates an Auger spectrum as shown in FIG. 2 on the basis of the spectral signal stored in the storage device 84.

The detection depth calculating portion 76 calculates the electron detection depth from the detected electron kinetic energy. For example, the detection depth calculating portion 76 calculates the electron detection depth by obtaining information about the electron kinetic energy from the spectrum generated by the spectrum generating portion 74 and finding the mean free path from the obtained electron kinetic energy.

Alternatively, the detection depth calculating portion 76 may obtain information about the electron kinetic energy from the spectral signal stored in the storage device 84 and calculate the detection depth.

As shown in FIG. 5, the display controller 78 provides control such that the electron kinetic energy is plotted on the horizontal axis of the spectrum generated by the spectrum generating portion 74 and displayed on the display device 82 and that the electron detection intensity is plotted on the vertical axis. Furthermore, the display controller 78 provides control such that the electron kinetic energy and information about the detection depth are interrelated and displayed on the display device 82. As a consequence, a spectral screen (FIG. 5) including the spectrum and information about the detection depth is displayed on the display device 82.

The surface analysis instrument 100 associated with the first embodiment has the following features.

The surface analysis instrument 100 includes the detection depth calculating portion 76 for calculating the electron detection depth from the detected electron kinetic energy and the display controller 78 for providing control such that a spectrum and information about the electron detection depth calculated by the detection depth calculating portion 76 are displayed on the display device 82. Since the spectrum and the information about the detection depth are displayed on the display device 82, the results of a measurement can be presented intelligibly.

In the surface analysis instrument 100, the display controller 78 provides control such that the electron kinetic energy and information about the detection depth are interrelated and displayed on the display device 82. In consequence, the results of a measurement can be presented in an intelligible fashion.

In the surface analysis instrument 100, the display controller 78 provides control such that the electron kinetic energy is plotted on the horizontal axis (first axis) of a spectrum displayed on the display device 82 and that the detection intensity is plotted on the vertical axis (second axis). Furthermore, the display controller 78 provides control such that information about the depth of detection is plotted on the third axis extending along the horizontal axis (first axis) of the spectrum displayed on the display device 82. Consequently, information about the detection depth is plotted on the axis extending along the axis on which the electron kinetic energy is plotted, and is displayed on the display device 82. As a result, the results of a measurement can be presented in an intelligible way.

### 2. Second Embodiment

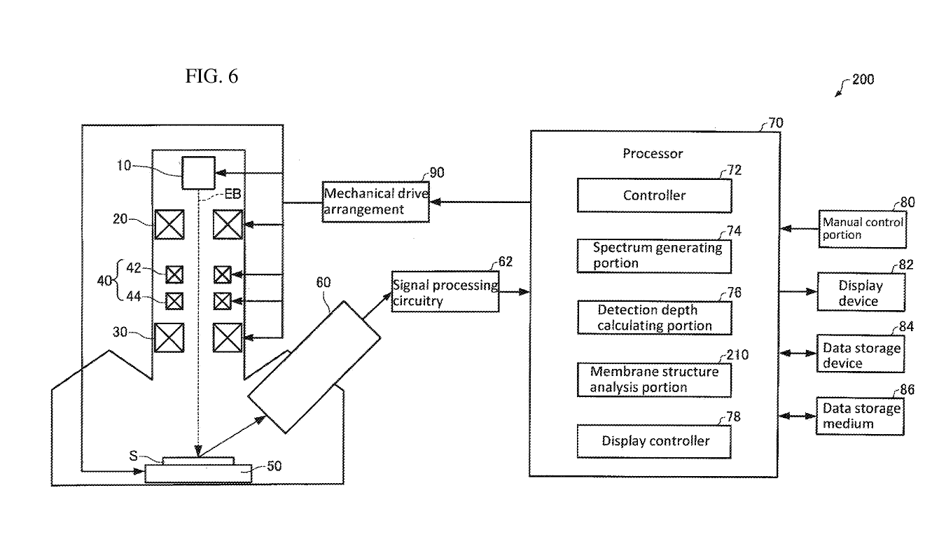

A surface analysis instrument associated with a second embodiment of the present invention is next described by referring to FIG. 6, where the instrument is generally indicated by reference numeral 200.

In this FIG. 6 and above cited figures, those components of the surface analysis instrument 200 associated with the second embodiment which are similar in function to their respective counterparts of the surface analysis instrument 100 associated with the first embodiment are indicated by the same reference numerals in these various figures and a description thereof is omitted.

In the surface analysis instrument 200, the processor 70 further includes a membrane structure analysis portion 210. The membrane structure analysis portion 210 finds a membrane structure of the sample S from the spectrum generated by the spectrum generating portion 74.

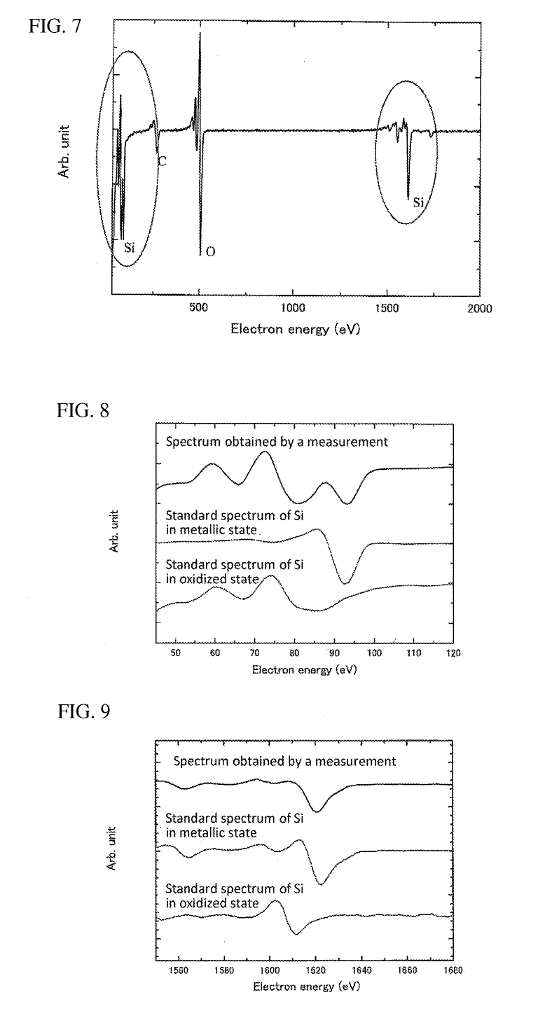

One example of method of finding the membrane structure is described now. FIG. 7 shows one example of Auger spectrum obtained by measuring a silicon substrate surface by the surface analysis instrument 200. In the spectrum of FIG. 7, a peak of Si appears. In addition, C (carbon) and O (oxygen) have been detected. It is considered that the detected oxygen is produced by natural oxidation of silicon within atmosphere. Furthermore, it is considered that the detected carbon is an adhering substance due to contamination of the silicon substrate surface.

FIG. 8 is an enlarged view of an Si LVV peak appearing near 90 eV of the spectrum shown in FIG. 7. FIG. 8 also shows a standard spectrum of LVV peak of Si in metallic state and a standard spectrum of LVV peak of Si in oxidized state. A standard spectrum is obtained by measuring a sample having a detection area which is totally composed of an element of interest.

Waveform separation was applied to the Si LVV peak shown in FIG. 8 by a non-negative constrained least squares method, using the standard spectrum of the LVV peak of Si in metallic state and the standard spectrum of the LVV peak of Si in oxidized state. It has been found that Si in metallic state and Si in oxidized state were both detected.

FIG. 9 is an enlarged view of the KLL peak of Si appearing near 1,600 eV of the spectrum shown in FIG. 7. Furthermore, FIG. 9 shows the standard spectrum of the KLL peak of Si in metallic state and the standard spectrum of the KLL peak of Si in oxidized state.

Waveform separation was applied to the KLL peak of Si shown in FIG. 9 by a non-negative constrained least squares method, using the standard spectrum of the KLL peak of Si in metallic state and the standard spectrum of the KLL peak of Si in oxidized state. It has been found that most of Si was Si in metallic state though a trace amount of Si in oxidized state was detected.

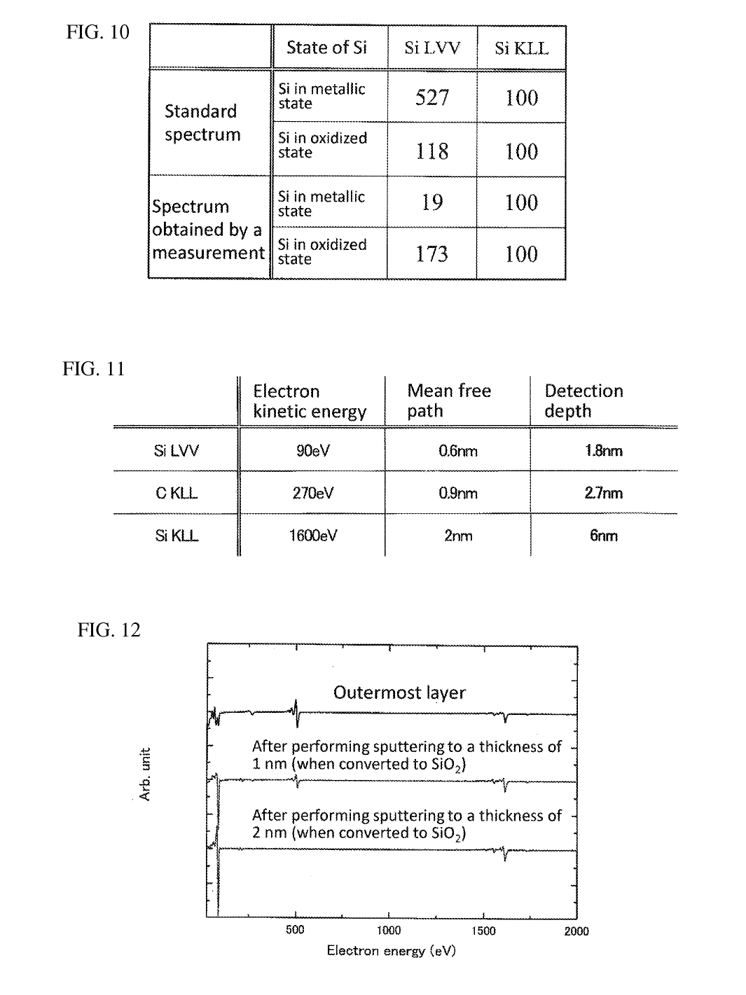

FIG. 10 is a table showing the intensity ratio between the LVV peak of Si and the KLL peak of Si in the spectrum shown in FIG. 7. This intensity ratio has been found by subjecting the LVV peak of Si and the KLL peak of Si to waveform separation. In the table of FIG. 10, the intensity ratio between the LVV peak of Si and the KLL peak of Si in each standard spectrum is given as a comparative example. In the table of FIG. 10, numerical values are normalized such that the intensity of the KLL peak of Si of each spectrum is equal to 100.

As shown in FIG. 10, the intensity ratio between the LVV peak of Si in metallic state and the KLL peak of Si in the standard spectrum was 527:100. In contrast, the intensity ratio between the LVV peak of Si in metallic state and the KLL peak of Si in the spectrum obtained by a measurement was 19:100. The intensity ratio between the LVV peak of Si in oxidized state and the KLL peak of Si in the standard spectrum was 118:100. In contrast, the intensity ratio between the LVV peak of Si in oxidized state of the spectrum obtained by a measurement and the KLL peak of Si was 173:100.

That is, in the Si in metallic state measured, the ratio of the intensity of the KLL peak of Si having a greater escape depth is higher than in the standard spectrum. In the Si in oxidized state measured, the ratio of the LVV peak of Si having a smaller escape depth is higher than in the standard spectrum.

FIG. 11 is a table showing relationships among electron kinetic energy, mean free path, and detection depth. As shown in this table, the detection depth of the LVV peak of Si having a kinetic energy of 90 eV at which the peak is detected on the lower-energy side is approximately 1.8 nm. On the other hand, the detection depth of the KLL peak of Si having a kinetic energy of 1,600 eV at which the peak is detected on the higher-energy side is approximately 6 nm. The detection depth of the KLL peak of C having a kinetic energy of 270 eV is approximately 2.7 nm. Each detection depth has been calculated by tripling the mean free path.

The membrane structure of each sample can be estimated from the tables of FIGS. 10 and 11. Specifically, in spite of the fact that C adheres to the outermost layer of the sample, the LVV peak of Si on the lower-energy side is detected. Thus, it can be seen that the thickness of the layer of C is equal to or less than 1.8 nm. From the LVV peak of Si on the lower-energy side, Si in metallic state is detected as well as Si in oxidized state. Furthermore, for the KLL peak of Si on the higher-energy side, Si in metallic state is prevalent. Therefore, it is estimated that the thickness of the oxide film is about from 2 nm to 6 nm.

FIG. 12 shows an Auger spectrum obtained after performing sputtering to a thickness of 1 nm (when converted to SiO₂) on a silicon substrate surface by Ar ions and an Auger spectrum obtained after performing sputtering to a thickness of 2 nm (when converted to SiO₂) on a silicon substrate surface by Ar ions. As shown in FIG. 12, after performing sputtering to a thickness of 2 nm, C and O which were detected prior to the sputtering are no longer detected. This shows that the thicknesses of layers of C and O are equal to or less than 2 nm. Accordingly, it is understood that the aforementioned estimation is correct.

Using this technique, the membrane structure analysis portion 210 can find a membrane structure, for example, by comparing the intensity ratio between a lower-energy side peak and a higher-energy side peak of an element of interest in a spectrum obtained by a measurement with the intensity ratio between a lower-energy side peak and a higher-energy side peak in the standard spectrum of the element of interest.

The membrane structure analysis portion 210 compares the intensity ratio of the standard spectrum and the intensity ratio of the spectrum obtained by a measurement. If the ratio of the intensity of the lower-energy side peak of the element of interest in the spectrum obtained by the measurement is higher, the analysis portion 210 judges that the element of interest is located near the surface of the sample. Furthermore, the membrane structure analysis portion 210 compares the intensity ratio of the standard spectrum and the intensity ratio of the spectrum obtained by the measurement. If the ratio of the intensity of the higher-energy side peak of the element of interest in the spectrum obtained by the measurement is greater, the analysis portion 210 judges that the element of interest is located inside of the sample. Information about the standard spectrum is previously stored, for example, in the storage device 84.

The membrane structure analysis portion 210 may estimate a membrane structure by finding a detection depth of an element of interest from a detection depth calculated by the detection depth calculating portion 76.

If peaks of an element of interest overlap, the membrane structure analysis portion 210 separates them by performing waveform separation and finds the intensities of peaks. That is, the membrane structure analysis portion 210 finds a membrane structure by comparing the intensity ratio of peaks obtained by waveform separation computation and the intensity ratio of peaks of the corresponding standard spectrum.

One example of processing performed by the membrane structure analysis portion 210 in a case where the spectrum shown in FIG. 7 is obtained by a measurement is described below.

First, the membrane structure analysis portion 210 subjects the spectrum shown in FIG. 7 and obtained by a measurement to waveform separation by the use of standard spectra (see FIGS. 8 and 9), and finds the intensity of an element of interest (in this example, Si in metallic state and Si in oxidized state) (see FIG. 10).

Then, the membrane structure analysis portion 210 compares, for Si in metallic state, the intensity ratio (LVV peak of Si:KLL peak of Si=527:100) of the standard spectrum and the intensity ratio (LVV peak of Si:KLL peak of Si=19:100) of a spectrum obtained by a measurement. Since the intensity of the higher-energy side peak of Si in metallic state is accounts for a higher proportion as compared with the intensity ratio of the standard spectrum, the membrane structure analysis portion 210 judges that the Si in metallic state is located inside the sample.

Similarly, the membrane structure analysis portion 210 compares, for Si in oxidized state, the intensity ratio (LVV peak of Si:KLL peak of Si=118:100) of the standard spectrum and the intensity ratio (LVV peak of Si:KLL peak of Si=173:100) of a spectrum obtained by a measurement. Since the ratio of the intensity of the lower-energy side peak is higher than the intensity ratio of the standard spectrum regarding Si in oxidized state, the membrane structure analysis portion 210 judges that the Si in oxidized state is located in the surface of the sample.

Furthermore, the membrane structure analysis portion 210 judges that C is located in or near the surface of the sample, based on information about the detection depth shown in FIG. 11.

Then, the membrane structure analysis portion 210 outputs information as to a membrane structure, indicating that SiO₂ (silicon in oxidized state) is located in or near the surface of the sample and that Si (silicon in metallic state) is located inside of the sample. The information about the membrane structure found by the membrane structure analysis portion 210 is stored, for example, in the storage device 84.

The display controller 78 provides control such that the information about the membrane structure of the sample S found by the membrane structure analysis portion 210 is displayed on the display device 82.

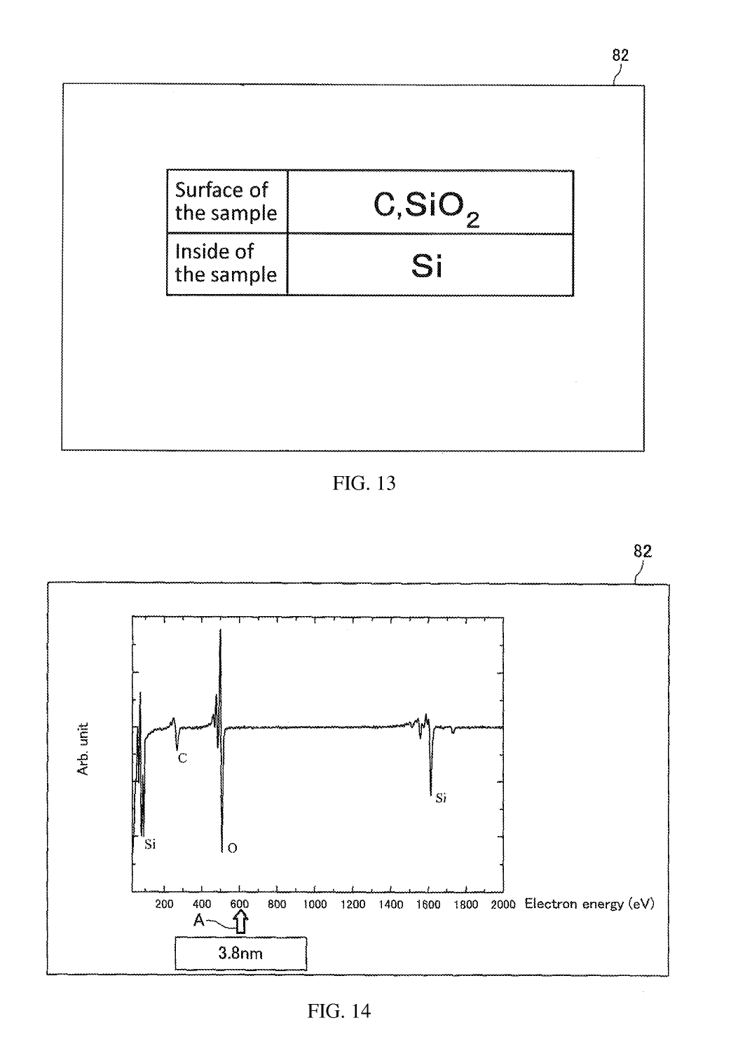

FIG. 13 shows one example of display screen showing information about a membrane structure presented on the display device 82 by the display controller 78. The display controller 78 displays information about a membrane structure of the sample S as a table on the display device 82 as shown in FIG. 13. The display controller 78 may display two display areas on one display screen in an unillustrated manner. One display area is a spectral display area showing the spectrum of FIG. 5 and information about a detection depth. The other display area indicates information about the membrane structure of the sample S shown in FIG. 13.

The surface analysis instrument 200 has the following features. The surface analysis instrument 200 has the membrane structure analysis portion 210 for finding a membrane structure of the sample S from a spectrum. The display controller 78 provides control such that information about the membrane structure of the sample S found by the membrane structure analysis portion 210 is displayed on the display device 82. Since information about the membrane structure is displayed on the display device 82 under control of the display controller 78, the results of a measurement can be presented in an intelligible manner.

### 3. Modification

It is to be understood that the present invention is not restricted to the above embodiments or its modifications. Rather, the embodiments can be implemented in various modified forms without departing from the gist of the invention.

For example, in the surface analysis instrument 100 associated with the first embodiment, the display controller 78 provides control such that information about a detection depth is plotted on an axis that extends along the horizontal axis of a spectrum and displayed on the display device 82 as shown in FIG. 5.

In contrast, in the present modification, the manual control portion 80 responds to an operation or manipulation for selecting an electron kinetic energy. At this time, the display controller 78 provides control such that information about a detection depth corresponding to the selected electron kinetic energy is displayed on the display device 82.

FIG. 14 shows one example of display screen presented on the display device 82 to show detection depths. As shown in FIG. 14, if a user selects a desired electron kinetic energy (600 eV in the illustrated example), for example, by manipulating the manual control portion 80 to move an arrow A shown on the display device 82, the display controller 78 displays information about the detection depth (3.8 nm in the illustrated example) corresponding to the selected electron kinetic energy on the display device 82. Information about the detection depth is arithmetically found by the detection depth calculating portion 76.

In this way, in the present modification, when the manual control portion 80 responds to a manual control operation for selecting an electron kinetic energy, the display controller 78 displays information about a detection depth corresponding to the selected electron kinetic energy on the display device 82 and, therefore, the results of a measurement can be presented intelligibly.

Similarly, in the surface analysis instrument 200 associated with the second embodiment, if the manual control operation 80 responds to a manual control operation for selecting an electron kinetic energy, the display controller 78 may provide control such that information about a detection depth corresponding to the selected electron kinetic energy is displayed on the display device 82. Consequently, the results of a measurement can be presented in an easily understandable manner.

In the above embodiment, each of the surface analysis instruments 100 and 200 is an AES (Auger electron spectroscopy) analyzer. The surface analysis instrument associated with the present invention may also be an XPS (X-ray photoelectron spectroscopy) analyzer that is an instrument for analyzing a sample by X-ray photoelectron spectroscopy, which is a technique for investigating the electronic state of a solid by irradiating the solid with a certain energy of X-rays and measuring the energies of photoelectrons ejected out by the photoelectric effect.

The present invention embraces configurations substantially identical (e.g., in function, method, and results or in purpose and advantageous effects) with the configurations described in the embodiments of the invention. Furthermore, the invention embraces configurations described in the embodiments and including portions which have non-essential portions replaced. In addition, the invention embraces configurations which produce the same advantageous effects as those produced by the configurations described in the embodiments or which can achieve the same objects as the configurations described in the embodiments. Further, the invention embraces configurations which are similar to the configurations described in the embodiments except that well-known techniques have been added.

Having thus described my invention with the detail and particularity required by the Patent Laws, what is desired protected by Letters Patent is set forth in the following claims.

The invention claimed is:

1. A surface analysis instrument for obtaining a spectrum by irradiating a sample with an electron beam or X-rays and detecting electrons emanating from the sample, said surface analysis instrument comprising:
a detection depth calculating portion for calculating a detection depth of electrons from kinetic energies of the detected electrons; and
a display controller for providing control such that the spectrum and information about the detection depth of electrons calculated by the detection depth calculating portion are displayed on a display device.

2. The surface analysis instrument as set forth in claim 1, wherein said display controller provides control such that electron kinetic energy and the information about the detection depth are interrelated and displayed on said display device.

3. The surface analysis instrument as set forth in claim 2, further comprising a membrane structure analysis portion for finding a membrane structure of said sample from said spectrum, and wherein said display controller provides control such that the information about the membrane structure of the sample found by the membrane structure analysis portion is displayed on said display portion.

4. The surface analysis instrument as set forth in claim 3, wherein said display controller provides control such that electron kinetic energy is plotted on a first axis of said spectrum displayed on the display device and that detection intensity is plotted on a second axis of the spectrum.

5. The surface analysis instrument as set forth in claim 4, wherein said display controller provides control such that said information about the detection depth is plotted on a third axis extending along said first axis and displayed on said display device.

6. The surface analysis instrument as set forth in claim 5, further comprising a manual control portion capable of responding to a manual control operation for selecting an electron kinetic energy, and wherein, if the manual control portion responds to the manual control operation, said display controller provides control such that said information about the detection depth corresponding to the selected electron kinetic energy is displayed on said display device.
